(19) United States
(12) Patent Application Publication
(10) Pub. No.: US 2025/0345910 A1
(43) Pub. Date: Nov. 13, 2025

(54) A Pipe Clip Dispensing Device

(71) Applicant: Hawthorne Holdings Pty Ltd, Queensland (AU)

(72) Inventors: Steve Hill, New South Wales (AU); Greg Morwood, Queensland (AU); Tony Mitchell, Queensland (AU)

(73) Assignee: Hawthorne Holdings Pty Ltd, Queensland (AU)

(21) Appl. No.: 18/869,513

(22) PCT Filed: May 31, 2023
(86) PCT No.: PCT/AU2023/050470

§ 371 Date: Nov. 26, 2024

(30) Foreign Application Priority Data
May 31, 2022 (AU) 2022901471

(51) Int. Cl. B25C 7/00; F16B 2/20

(52) U.S. Cl. CPC B25C 7/00; F16B 2/20

(57) ABSTRACT

A pipe clip dispensing device (300) for facilitating mounting of a pipe to a support, includes a pipe clip cartridge (302) defining an internal pipe clip chamber for receiving a plurality of pipe clips therein and providing a pipe clip positioning region (314) for holding and positioning a pipe clip of the plurality of pipe clips for fixing to the support by a fastener delivered from a fastener delivery part (402) of a fastener gun (400) and also includes a fastener gun mounting (304) for mounting the clip cartridge (302) on the fastener gun (400). The clip cartridge (302) is coupled to the fastener gun mounting (304) such that the positioning region (314) is moveable towards and away from the fastener delivery part (402) of the fastener gun (400).

### FIELD

The present disclosure relates to a pipe clip dispensing device for dispensing pipe clips for use in securing a pipe clip to a support, and extends to a fastener gun in combination with a pipe clip dispensing device. The disclosure also relates to a method of mounting a pipe clip on a support for holding a pipe.

### Definition

In this specification, the term ‘comprising’ is intended to denote the inclusion of a stated integer or integers, but not necessarily the exclusion of any other integer, depending on the context in which that term is used. This applies also to variants of that term such as ‘comprise’ or ‘comprises’.

In the present specification and claims the term “pipe” is used to mean any suitable water pipe or gas pipe, such as (but not limited to) water and gas pipes which are used in residential accommodation, and also to include elongate objects which are frequently secured to a wall or other support in a similar manner, such as (but not limited to) electrical cable, electrical conduit or the like.

The term “pipe clip” is used to mean a device securable to a support, such as (but not limited to) a wall, by a fastener, and which is for securing a pipe to the support, having a part configured to retain the pipe, and a part configured for passage of a fastener such as (but not limited to) a nail or screw therethrough, so that the pipe clip is securable to the support by the fastener.

The term “fastener gun” is used to mean a tool, such as (but not limited to) a nail gun, that automatically positions a fastener relative to a powered driving arrangement thereof and drives the fastener into a work piece. The driving arrangement may be pneumatic, combustion or electric. The fastener may be a nail, screw or staple.

### BACKGROUND

Pipe clips are known in the prior art and are used for mounting pipes or conduits on a support and holding the pipes or conduits against, or adjacent, the surface of the support. The support typically might comprise a wall of a building, e.g. a building providing residential accommodation.

A prior art pipe clip comprises a pipe holding formation for releasably receiving a pipe therein and holding it, and a fixing formation for fixing the pipe clip to a support. The pipe clips are fixed onto the support and the pipe holding formation holds and retains the pipes or conduits in position mounted on the support. Pipe clips are widely used in building construction to fix plumbing pipes to their adjacent support structures. The pipe clips are spaced apart from each other along the length of the pipe and thereby provide suitable mounting support for the pipe along its length.

One example of a basic pipe clip 10 is shown in FIG. 1. It comprises a curved, generally part-circular, pipe holding formation 12 and a fixing formation 14 adjacent the pipe holding formation 12. The fixing formation 14 includes a through bore forming a linear fastener passage 15, for passage of a fastener, such as a nail 16 or screw (not shown), therethrough. The fixing formation 14 may comprise a fixing post 18 with the linear fastener passage 15 passing therethrough.

Another example of a prior art pipe clip 20 is shown in FIG. 2. The pipe clip 20 in FIG. 2 comprises first and second pipe holding formations 22, 24 extending parallel to each other but spaced apart from each other, and a central fixing formation 26 connecting and between the first and second pipe holding formations 22, 24, and to which the first and second curved pipe holding formations 22, 24 are connected at respective first ends thereof. The fixing formation 26 is linear and may be regarded as comprising a fixing post 27 which has a through bore forming a linear fastener passage 28 extending therethrough, for passage of a fastener, such as a screw 29 or nail (not shown), therethrough.

Respective second ends the first and second pipe holding formations 22, 24 which are distal from the central fixing formation 26 are connected by a bridging part 30, which provides a base surface part 32 to engage a support to which the pipe clip 20 is, in use, fixed.

Attached to the fixing formation 26, and extending generally between the first and second pipe holding formations 22, 24, is a further curved pipe holding formation 34.

The curved pipe holding formations 22, 24, 34 comprise resilient arcuate parts which can be deformed to receive a pipe, and then return to (or close to) their non-deformed configurations, retaining the pipe therein. The first and second curved pipe holding formations 22, 24 are configured and dimensioned to effectively hold a pipe of a given diameter (or range of diameters). The further curved pipe holding formation 34 is configured to effectively hold a pipe of a smaller diameter (or range of diameters) than the pipe size for which the first and second curved pipe holding formations 22, 24 are intended.

In the prior art pipe clips for plumbing pipes are typically supplied to a plumber in the form of a bag of discrete pipe clips. Further the prior art pipe clips are typically sold with a fastener received within the fastener passage, e.g., partly inserted in the fastener passage so that the fastener is positioned suitably for driving into a support.

In use on a building site a plumber manually takes out a pipe clip and positions it over a pipe to be secured to a support. The plumber pushes the pipe into the pipe holding formation of a pipe clip, then positions the pipe clip so that a base part contacts the support and so that the fastener is appropriately positioned, and then drives the fastener into the support, using a driving tool, often a manual driving tool, such as a hammer or screwdriver. Positioning and alignment of the driving tool relative to the fastener is manual. The support is typically an adjacent timber frame member or a cladding or a wall.

Thus, this process is very manual and time consuming as many pipe clips may be required, each individual pipe clip has to be physically and manually pressed around the pipe and then the fastener hammered or screwed into the support. If nails are used, driving the fastener into the surface by hammering is generally an entirely manual process. If screws are used, a powered screwdriver or rotary drill with a screwdriver bit may be used, but the process of manually mounting each pipe clip onto a pipe, then placing the screwdriver bit in contact with the screw head, including achieving correct positioning and alignment, is still laborious. Further the efficiency of the process depends on the skill and dexterity of the plumber performing the task. This process takes time and requires a lot of effort on the part of the plumber. It would clearly be advantageous if it could be done more time efficiently.

### SUMMARY

Applicant recognises that it would be beneficial if an improved technique could be devised for mounting pipe clips on their pipe and driving their associated fasteners into an adjacent support.

In particular, Applicant recognises it would be advantageous if a device could be devised for positioning pipe clips to facilitate use of fastener gun to secure the pipe clips to a support. It would therefore be desirable to provide an apparatus and/or device which, at least in an embodiment can achieve this, and/or which at least provides a useful alternative to known techniques or securing pipe clips.

According to a first aspect of the invention there is provided a pipe clip dispensing device for facilitating mounting of a pipe to a support, the pipe clip dispensing device comprising:
a pipe clip cartridge defining an internal pipe clip chamber for receiving a plurality of pipe clips therein and providing a pipe clip positioning region for holding and positioning a pipe clip of the plurality of pipe clips for fixing to the support by a fastener delivered from a fastener delivery part of a fastener gun; and
a fastener gun mounting for mounting the clip cartridge on the fastener gun, wherein the clip cartridge is coupled to the fastener gun mounting such that the pipe clip positioning region is moveable towards and away from the fastener delivery part of the fastener gun.

In an embodiment the clip cartridge is configured so that in use a pipe clip being held and positioned by the pipe clip positioning region moves with the holding region, so that the pipe clip is moveable towards and away from the fastener delivery part of the fastener gun.

Movement of the positioning region and/or pipe clip towards the fastener delivery part of the fastener gun immediately prior to the delivery of a fastener by the fastener gun has been found to be advantageous. First, it facilitates provision of the opening of the fastener passage of the pipe clip at or close to the leading end of the fastener prior to its delivery, which reduces the likelihood of misalignment of the fastener passage and fastener. Second, fastener guns, and in particular nail guns, are typically provided with a safety mechanism comprising a work contact element, adjacent the fastener delivery part, for contacting a work surface, such that the safety mechanism is disengaged (to allow operation of the fastener gun) when the work contact element is in contact with, and pressed against, a work surface. Allowing movement of the positioning region of the pipe clip cartridge towards and away from the fastener delivery part of the fastener gun allows a user to make a contact part of the positioning region bear against the work contact element (to allow operation of the fastener gun) when the user wishes to operate the fastener gun, and also allows the pipe clip in the positioning region to be mounted on (e.g. clipped onto) a pipe while the positioning region of the pipe clip cartridge is relatively far from the fastener delivery part of the fastener gun, so that the safety mechanism is operative and the fastener gun cannot be operated, thereby maintaining safety.

In an embodiment the pipe clip positioning region comprises a contact region for contacting and bearing against a work contact element of a safety mechanism of a fastener gun.

In an embodiment the contact region comprises a replaceable contact element.

In an embodiment the contact region comprises a material which is a different material to at least most of the rest of the pipe clip cartridge.

In an embodiment the contact region comprises a material which is a tougher and/or harder material to at least most of the rest of the pipe clip cartridge.

In an embodiment the contact region comprises a material comprising a rubber material.

In an embodiment the contact region comprises a material comprising an elastomer material.

In an embodiment the contact region comprises a material comprising a thermoplastic elastomer (TPE) material.

In an embodiment the contact region comprises a material comprising polyurethane.

In an embodiment the contact region comprises a material comprising thermoplastic polyurethane (TPU).

In an embodiment the contact region comprises an insert.

In an embodiment the contact region comprises a replaceable insert.

In an embodiment the clip cartridge is pivotally coupled to the fastener gun mounting.

In an embodiment the pipe clip dispensing device comprises a pivot joint by which the pipe clip cartridge is mounted on the fastener gun mounting that permits the clip cartridge to pivot relative to the fastener gun mounting.

In an embodiment the pivot joint comprises at least one first pivot part provided on the pipe clip cartridge and at least one second pivot part provided on the fastener gun mounting, and a pivotal connection between the at least one first pivot part and the at least one second pivot part so that the pipe clip cartridge can pivot relative to the fastener gun mounting.

In an embodiment the at least one first pivot part is provided on a side of the clip cartridge distal from the gun mount.

In an embodiment the at least one second pivot part projects from the rest of the gun mount generally in a direction away from the fastener gun, and extends to a distal side of the pipe clip cartridge.

In an embodiment the pipe clip cartridge comprises a cartridge body having a pipe clip inlet through which a plurality of pipe clips is fed into the cartridge and a pipe clip outlet configured to allow pipe clips to exit the cartridge body therethrough.

In an embodiment the pipe clip outlet is configured to allow pipe clips to exit the cartridge body therethrough when they are mounted on a pipe.

In an embodiment the pipe clip outlet is configured to allow a pipe clip to be mounted on a pipe before exiting the exit the cartridge body, and to exit the cartridge body therethrough after mounting on a pipe.

In an embodiment the clip outlet is formed substantially at the pipe clip positioning region.

The plurality of pipe clips may comprise a string of pipe clips.

The string of pipe clips may comprise a plurality of pipe clips arranged in a line, where adjacent pipe clips are connected to each other by a breakable connecting element.

In an embodiment the string of pipe clips holds each of the clips in the string in a predetermined orientation relative to each other.

In an embodiment the string of pipe clips comprises 4 to 12 pipe clips, e.g. 6 to 8 pipe clips.

In an embodiment the breakable connecting element may comprise a frangible connection that can be broken when the pipe clip dispensing device is pulled away from a pipe clip once it has been fastened to a support.

In an embodiment the pipe clip cartridge provides a clip path from a clip inlet of the pipe clip cartridge to the pipe clip positioning region

The internal pipe clip chamber of the cartridge body may form the clip path, from the clip inlet to the clip outlet, through which the plurality of clips is progressively advanced.

In an embodiment the clip path of the cartridge provides clip guiding formations for co-operating with complementary guide formations provided on each clip.

In an embodiment the clip guiding formations comprise grooves configured to cooperate with complementary guide formations comprising projections provided or formed on each clip.

In an embodiment the clip guiding formations comprise elongate projections configured to cooperate with complementary guide formations e.g., comprising grooves provided on each clip.

In an embodiment the clip guiding formations are oriented substantially in the direction in which the plurality of clips is progressively advanced along the clip path.

In an embodiment at least two clip guiding formations are provided that are located on opposed sides of the clip path.

In an embodiment at least two clip guiding formations are provided asymmetrically on opposed sides of the clip path.

The pipe clip positioning region may comprise a clip mounting bay into which the pipe clips are sequentially displaced, and from which each clip is mounted on a pipe and then separated from the pipe clips remaining in the clip cartridge.

The pipe clip positioning region may comprise a receiving formation for receiving and positioning at least part of a post of a pipe clip, wherein the post provides a fastener passage therein. It will be appreciated that suitably positioning the post of a pipe clip in a desired predetermined orientation and position relative to a fastener delivery part of the fastener gun will also position the fastener passage in a desired predetermined orientation and position relative to a fastener delivery part.

The clip cartridge may comprise a clip advancing arrangement for advancing the plurality of clips each time a clip exits the clip cartridge.

The clip advancing arrangement may comprise a biassing member bearing against the plurality of clips in a direction towards the pipe clip positioning region.

The biassing member may be spring loaded and configured to urge the plurality of clips in the cartridge passage in the direction towards the pipe clip positioning region.

One end of the biassing member may bear against the cartridge body and the other end may bear against a rearmost clip of the plurality of clips.

The biassing member may be spring loaded by a spring arrangement.

The spring arrangement may comprise a coil of flat resilient material.

The biassing member may be spring loaded by a clock spring arrangement.

The clip advancing arrangement may further include a check arrangement for selectively disengaging the clip advancing arrangement to replace or replenish a plurality of clips in the clip cartridge.

The clip inlet and the clip path may be configured so that the clips can only be inserted into the clip cartridge in a correct orientation.

The clip mounting bay may be located at or adjacent the clip outlet of the cartridge body.

The clip mounting bay may comprise a clip locator for engaging a clip when it enters the clip mounting bay and locating it in position for mounting on a pipe.

The clip locator may be configured to complement a portion of the pipe clip against which it abuts in use.

The clip locator may be configured to abut against the fixing formation or post of a pipe clip.

The clip locator may also be configured to abut against portions of the pipe holding formations that are adjacent thereto.

The clip locator may be configured to complement a portion of a clip which includes all or part of a clip tab that remains attached to the clip after separation of the clip from another clip previously attached thereto via the clip tab.

The clip locator may provide a recess complementary to the size and shape of the portion of a tab.

The clip locator may comprise at least a resilient locating formation that is deformed when the pipe clip is separated from the clip mounting device and the string of pipe clips.

The clip locator may engage curved arcuate sections (e.g. pipe holding formations) on each side of the pipe clip.

The fastener gun mounting may comprise a mounting member for releasable mounting to a complementary mounting formation on the fastener gun.

The fastener gun mounting may comprise a mounting member for releasable mounting to a complementary mounting formation on a fastener magazine of the fastener gun.

The fastener gun mounting may be integrally formed as part of a fastener gun.

The device may therefore further comprise the fastener gun.

The fastener gun mounting may comprise a channel, track or rail member for releasably engaging a complementary formation on the fastener gun, e.g. on a handle, body or fastener magazine of the fastener gun.

The fastener gun mounting may comprise opposed side parts which may co-operate to lock the fastener gun mounting in position relative to a part of the fastener gun which extends between the opposed side parts.

The fastener gun mounting may comprise opposed side parts which may be forced together to lock the fastener gun mounting in position relative to a part of the fastener gun which extends between the opposed side parts.

In one form the fastener gun mounting comprises a channel member which can be displaced over a complementary formation on the fastener magazine of the fastener gun into an engaged position.

In an embodiment said channel member comprises said opposed side parts which may act to lock the fastener gun mounting in position.

The fastener gun mounting may further comprise a spacing member extending from a predetermined position on the fastener gun mounting to a predetermined position on the fastener gun.

The spacing member may comprise at least one engagement formation for engaging a predetermined feature on the fastener gun.

The spacing member may be configured so that the engagement formation is only able to be engaged with said predetermined feature when the fastener gun mounting is positioned or located correctly in position to provide alignment of a fastener passage of a pipe clip in the positioning region with a fastener being driven by the fastener gun.

The engagement formation may comprise a coupling formation for coupling to said predetermined feature on the fastener gun.

The spacing member may be configured so that the coupling formation is only able to be coupled to said predetermined feature when the fastener gun mounting is positioned correctly to provide alignment of a fastener passage of a pipe clip in the positioning region with a fastener being driven by the fastener gun.

The spacing member may comprise two arms that engage with two respective predetermined features on opposed sides of the fastener gun.

The predetermined feature on the fastener gun may comprise, for example, one or more screw holes or screw heads on the fastener gun.

The coupling formation may comprise, for example, a projection configured to be received in and/or coupled to a screw hole, or a loop or a cap configured to engage and/or couple to a screw head.

The spacing member may comprise a yoke member.

The fastener gun mounting may comprise at least one stop formation for limiting pivoting of the clip cartridge relative to the fastener gun mounting.

The stop formation may comprise an arcuate groove configured to receive a projection provided on the pipe clip cartridge.

According to a second aspect of the invention there is provided the pipe clip dispensing device defined in any other aspect of the invention in combination with a fastener gun.

In an embodiment the fastener gun comprises a fastener feed arrangement which automatically positions a fastener relative to a powered driving arrangement thereof.

The powered driving arrangement is configured to drive the fasteners sequentially into a work piece.

The powered driving arrangement may be, or example pneumatic, combustion or electric.

The fastener gun may be configured to drive fasteners from a fastener delivery part thereof.

In an embodiment, the fastener gun comprises a magazine for feeding a plurality of fasteners, sequentially, to the fastener delivery part thereof.

The magazine may comprise a housing which is integrally formed as part of the fastener gun.

The fastener gun may have a safety mechanism comprising a work contact element moveable between a safety position and a fastener driving position.

In an embodiment, the work contact element is configured so that when a forwardmost part of the work contact element is pressed against a support or substrate, it is moved in a rearward direction relative to the rest of the fastener gun, effecting disengagement of the safety mechanism which prevents operation of the fastener gun even when the trigger is operated.

The work contact element may be closely adjacent the fastener delivery part (sometimes called a muzzle or nose) of the fastener gun.

The work contact element may comprise a plurality of work contact parts thereof, arranged around the fastener delivery part, e.g. on opposed sides of the fastener delivery part.

The fastener may be a nail, screw or staple.

The fastener gun may comprise a handle part.

The fastener gun may comprise an activating trigger.

The fastener gun may be a fastener gun of the type in which the fastener magazine holder of the tool extends transverse to the driving direction of the fastener.

The fastener gun may be a fastener gun of the type in which the fastener magazine holder is at right angles to a driving direction of the fastener.

The fastener gun may be a fastener gun of the type in which the fastener magazine holder extends at a non-orthogonal angle to the driving direction.

The fastener gun may comprise a nail gun.

According to a third aspect of the invention there is provided a pipe clip dispensing device for facilitating mounting of a pipe to a support, the pipe clip dispensing device comprising:
a pipe clip cartridge defining an internal pipe clip chamber for receiving a plurality of pipe clips therein and providing a pipe clip positioning region for holding and positioning a pipe clip of the plurality of pipe clips for fixing to the support by a fastener delivered from a fastener delivery part of a fastener gun; and
a fastener gun;
wherein the clip cartridge is coupled to a mounting part of the fastener gun such that the pipe clip positioning region is moveable towards and away from the fastener delivery part of the fastener gun.

Thus, the pipe clip dispensing device may be formed with an integral fastener gun as a part thereof. In such a case it is not required to releasably mount a fastener gun mounting to the fastener fun and the corresponding mounting formations are therefore not required.

Features describes above in relation to the first aspect may be incorporated mutatis mutandis into the second aspect. In particular, the pipe dispensing device may include any one or more features or combinations of features of the dispensing device or fastener gun in any other aspect of the invention.

According to fourth aspect of the invention there is provided a method of mounting a pipe clip on a support for holding a pipe, the method comprising:
providing a pipe clip dispensing device in accordance with the first aspect, mounted to a fastener gun, and the pipe clip device having a plurality of pipe clips loaded therein with a leading pipe clip in the positioning region;
mounting the pipe clip dispensing device up against a pipe on a support so that the leading pipe clip is pushed onto the pipe which is received in a pipe receiving formation of the leading pipe clip;
moving the fastener gun relative to the pipe receiving formation of the pipe clip cartridge so that a fastener dispensing part of the fastener gun is moved closer to the leading pipe clip; and
operating the fastener gun to drive a fastener from the fastener dispensing part of the fastener gun into a fastener passage of the leading fastener and into the support whereby to fix the pipe clip to the support.

In an embodiment, moving the fastener gun relative to the pipe receiving formation of the pipe clip cartridge so that a fastener dispensing part of the fastener gun is moved closer to the leading pipe clip, comprises disarming a safety feature of the fastener gun, to thereby permit the fastener gun to operate.

In an embodiment, moving the fastener gun relative to the pipe receiving formation of the pipe clip cartridge so that a fastener dispensing part of the fastener gun is moved closer to the leading pipe clip, comprises moving a leading end of a fastener into the fastener passage of the leading pipe clip, prior to operating the fastener gun to drive the fastener.

In an embodiment the method comprises moving the fastener gun and the pipe clip dispensing device away from the fixed leading pipe clip whereby to separate the fixed leading pipe clip from the positioning region and the pipe clips remaining in the pipe clip cartridge.

In an embodiment the method comprises use of a plurality of pipe clips configured as a string of pipe clips in which adjacent pipe clips are connected to each other by a breakable connecting element.

In an embodiment the method comprises moving the fastener gun and the pipe clip dispensing device away from the pipe whereby to detach the pipe clip from the remainder of the string of pipe clips.

In an embodiment the method further comprises operating the pipe dispensing device so that simultaneously with, or after, moving the fastener gun and the pipe clip dispensing device away from the fixed leading pipe clip to separate the leading pipe clip from the positioning region and the pipe clips remaining in the pipe clip cartridge, the next succeeding pipe clip in the clip cartridge is then displaced into the positioning region for mounting onto a pipe with the next use of the fastener gun.

In an embodiment moving the fastener gun and the pipe clip dispensing device away from the fixed leading pipe clip comprises moving the fastener gun and the pipe clip dispensing device away from the pipe.

In carrying out the method the pipe dispensing device and fastener gun may include any one or more features or combinations of features of the dispensing device or fastener gun described in any other aspect of the invention.

According to a fifth aspect of the invention there is provided a string of pipe clips for use in a pipe clip dispensing device for mounting a pipe on a support, the string of pipe clips comprising:
a plurality of pipe clips arranged in a line, wherein adjacent pipe clips are connected to each other by a breakable connecting element; and
wherein each pipe clip has clip guide formations for co-operating with complementary clip guiding formations on a pipe clip cartridge, the clip guide formations comprising projections, grooves, or a combination of at least one projection and at least one groove, provided on the pipe clip and oriented substantially parallel to the length direction of the line of pipe clips.

In an embodiment corresponding surfaces of the respective clip guide formations of respective clips are nonetheless substantially coplanar or co-linear.

In an embodiment the line of clips comprises a slanted configuration, such that corresponding base surfaces of the respective pipe clips are not co-planar, and in said line of clips corresponding surfaces of the respective clip guide formations of respective clips are nonetheless substantially coplanar or co-linear.

In an embodiment the clips have a post part that provides a fastener passage therethrough and at least one of the clip guide formations is provided on an external surface of the post part.

In an embodiment the breakable connecting element may utilise a frangible connection that can be broken when the pipe clip dispensing device is pulled away from a pipe clip that has been fastened to a support.

In an embodiment the guide formations provided on each clip are configured to co-operate with complementary clip guiding formations provided in a cartridge for dispensing the clips.

In an embodiment each breakable connecting element comprises a connecting tab between the adjacent pipe clips.

In an embodiment the line of clips may be formed from a thermoplastic material such as polyethelene, polypropylene or copolymers thereof.

In an embodiment the clips and breakable connecting elements may be integrally formed in a single manufacturing process, such as a moulding process, e.g., an injection moulding process.

In an embodiment the clips and breakable connecting elements may be formed in a moulding process, e.g., an injection moulding process.

In an embodiment, the clips may be separately formed and the breakable connecting elements may be introduced in a second process such as, for example, melt welding.

In an embodiment the material of the breakable connecting elements may be different from that of the pipe clips. It will be appreciated that this may have some advantages in addressing an apparent compromise between the desired degree of resilience of the clips to support a pipe and the required degree of frangibility of the breakable connecting elements.

In an embodiment, the breakable elements may be formed as a mechanical interlock system that is designed to withstand the forces of movement through the cartridge but will disconnect upon driving of a fastener through the fastener passage of a clip, and/or on relative movement of adjacent pipe clips in a predetermined direction. This may allow a user an option of using a preferred length of clips.

In an embodiment the clips in the line of clips may each have a central body part with a curved or arcuate first pipe receiving recess and two curved or arcuate arms spaced laterally on either side of the central body part. Each arm in combination defines a second pipe receiving recess that has an effective diameter less than that of the first recess. This allows the clip to support pipes of different diameter.

In an embodiment the clips have a base part that holds a held pipe away from a support or substrate surface so as to protect the pipe from abrasion against the support or substrate surface.

In an embodiment at least one of the clip guide formations is provided on an external surface of the post part.

The pipe clips themselves and the string of pipe clips may include any one or more of the features of pipe clips and strings of pipe clips in any other aspect of the invention.

According to another aspect of the invention there is provided a pipe clip for use in a pipe clip dispensing device, the pipe clip comprising:
a pipe retaining formation, defining a pipe receiving recess for retaining a pipe therein; and
a fixing formation providing a fastener passage for passage of a fastener therethrough, so that the pipe clip is securable to a support by the fastener; and
wherein the pipe clip has clip guide formations for co-operating with complementary clip guiding formations of the pipe clip dispensing device.

In an embodiment the clip guide formations comprise projections, grooves, or a combination of at least one projection and at least one groove, provided on the pipe clip.

In an embodiment the clip guide formations are arranged on opposed sides of the clip

In an embodiment the clip guide formations are arranged on opposed sides of the clip

In an embodiment the clip guide formations are arranged on opposed sides of the fixing formation.

In an embodiment the clip guide formations are arranged on opposed sides of a support post of the clip.

In an embodiment the clip guide formations are arranged asymmetrically on the clip.

In an embodiment the clip guide formations are arranged to correspond to an intended feed direction of the clip within the pipe clip dispensing device.

In an embodiment the pipe clip provides at least one base surface part for engaging a surface of a support to which the pipe clip is to be fixed to attach a pipe to the support.

In an embodiment the base surface part is configured, relative to the pipe retaining formation, so that the pipe clip, when fixed to the support, retains the pipe spaced from the surface of the support.

In an embodiment the clip guide formations are arranged so that they extend at an angle relative to the base surface part.

In an embodiment the clip guide formations are arranged so that they extend at a slanted angle relative to the base surface part.

In an embodiment the clip guide formations are arranged so that they extend at an angle which is not substantially parallel to nor substantially orthogonal to the base surface part.

According to yet another aspect of the invention there is provided a string of pipe clips for use in a pipe clip dispensing device for mounting a pipe on a support, the string of pipe clips comprising:
a plurality of pipe clips arranged in a line, wherein adjacent pipe clips are connected to each other by a breakable connecting element.

The pipe clips themselves and the string of pipe clips may include any one or more of the features of pipe clips and strings of pipe clips in any other aspect of the invention.

According to a further aspect of the invention there is provided a pipe clip dispensing device for mounting a pipe on a support, the pipe clip dispensing device comprising:
a clip cartridge defining an internal clip chamber for receiving a string of pipe clips therein; and
a fastener gun mounting for mounting the clip cartridge on a fastener gun, wherein the fastener gun mounting can pivot relative to the clip cartridge.

According to a further aspect of the invention there is provided a clip feeding device for mounting to a fastener gun having an actuator, a safety mechanism operatively associated with the actuator, the safety mechanism having a work contact element for contacting a work surface such that the safety mechanism can be disengaged when the work contact element is in contact with a work surface; the clip feeding device comprising:
a longitudinal body for receiving a length of pipe support clips frangibly connected together, each support clip having an open pipe holding recess and a fastener receiving bore;
wherein the body comprises an insert end for receiving the plurality of clips and a forward end for receiving a leading clip, the forward end having an opening and a clip holding arrangement for holding the clip in the opening; and
a mounting arrangement for pivotally mounting the body to the fastener tool, such that a user can pivot the body relative to the fastener tool, whereby pivotal movement cooperates with the safety mechanism of the fastener tool so as to disengage the safety mechanism when the leading clip is in a fastener path for receiving a fastener fired therefrom.

### BRIEF DESCRIPTION OF THE DRAWINGS

A pipe clip dispensing device and a combination of fastener gun and pipe clip dispensing device in accordance with the invention may manifest itself in a variety of forms. It will be convenient to hereinafter describe embodiments of the invention with reference to the accompanying diagrammatic drawings. The purpose of providing this detailed description is to instruct persons having an interest in the subject matter of the invention how to carry the invention into practical effect. However, it is to be clearly understood that the specific nature of this detailed description does not supersede the generality of the preceding summary section. In the drawings:

FIG. 1 is a drawing of a first type of pipe clip for mounting a pipe to a support in accordance with the prior art;

FIG. 2 is a drawing of a second type of pipe clip for mounting a pipe to a support in accordance with the prior art;

FIG. 3 is a perspective view from above and a first side of a pipe clip dispensing device in accordance with an embodiment of the present disclosure, mounted on a fastener gun;

FIG. 4 is a perspective view from below and a second side of the pipe clip dispensing device and fastener gun of FIG. 3, illustrating a string of pipe clips being loaded into the clip cartridge;

FIGS. 5 to 9 illustrate a single pipe clip used in the pipe clip dispensing device of FIGS. 3 and 4;

FIGS. 10 and 11 are different perspective views of a string of pipe clips used in the pipe clip dispensing device of FIGS. 3 and 4;

FIG. 12 is an exploded perspective view of the clip cartridge viewed from a direction of the clip inlet and showing a pipe clip received within the clip cartridge in its desired orientation;

FIG. 13 is a plan or end view, in the axial direction of the clip cartridge of FIG. 12, again showing a pipe clip within the cartridge;

FIG. 14 is a perspective view from above and the first side, schematically illustrating a stage in the process of attaching the pipe clip dispensing device of FIGS. 3 and 4 to a schematically illustrated fastener gun, representing a type that is commercially available;

FIGS. 15 and 16 are a perspective views from above and the second side, schematically illustrating use of a yoke or spacing member to help correctly locate the device of FIGS. 3 and 4 on a fastener gun;

FIG. 17(a) is an exploded partial perspective view of the pipe clip dispensing device of FIGS. 3 and 4, also showing part of a safety mechanism on the fastener gun;

FIGS. 17(b), 17(c) and 17(d) are respectively enlarged perspective, front and rear views of an insert shown in FIG. 17(a);

FIGS. 18(a), 19(a) and 20(a) are views, from the second side, of the pipe clip dispensing device of FIGS. 3 and 4 illustrating progressive movement, in this case pivoting, of the pipe clip cartridge relative to the fastener gun mounting and fastener gun;

FIGS. 18(b), 19(b) and 20(b) are enlargements of parts of FIGS. 18(a), 19(a) and 20(a), respectively;

FIG. 21(a) is a perspective view, from the front and second side, showing the pipe clip cartridge of the device of FIGS. 3 and 4, and part of a safety mechanism of a fastener gun, illustrating a pipe clip in a pipe clip positioning region of the cartridge clipped onto a pipe;

FIG. 21(b) is an enlargement of part of FIG. 21(a) showing some additional detail;

FIG. 21(c) corresponds to FIG. 21(b) but with the pipe and clip omitted to show internal detail of the pipe clip positioning region of the pipe clip cartridge;

FIG. 22 is a partial cross sectional view corresponding to FIG. 21(b), illustrating the clip positioning region of the pipe clip cartridge abutting a support to which the pipe and pipe clip are to be mounted, and having been moved sufficiently far towards a fastener located at a delivery part of a fastener gun that the leading end of the fastener is located in a fastener passage of the pipe clip;

FIG. 23 is a perspective view, from above and a second side, of the clip dispensing device, mounted on a fastener gun, of FIG. 3, illustrating a string of pipe clips being loaded into the clip cartridge; and

FIGS. 24 to 26 are a series of schematic drawings showing the sequence of actions undertaken during operation of the clip dispensing device.

### DETAILED DESCRIPTION

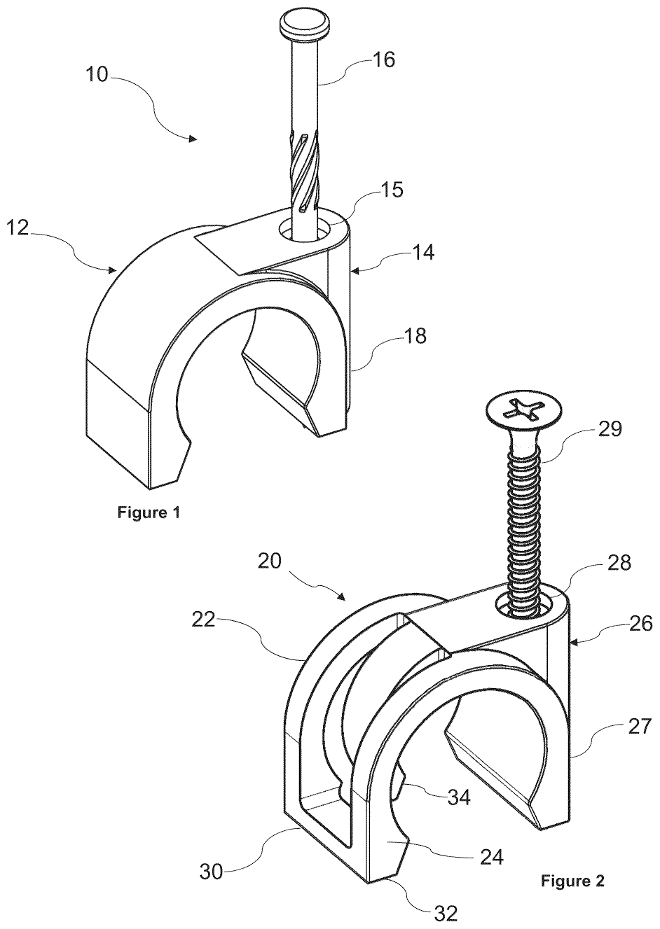

FIGS. 1 and 2 illustrate pipe clips that are known in the prior art and are used for mounting pipes onto supports such as walls and building structures. These figures have been described in the background section above.

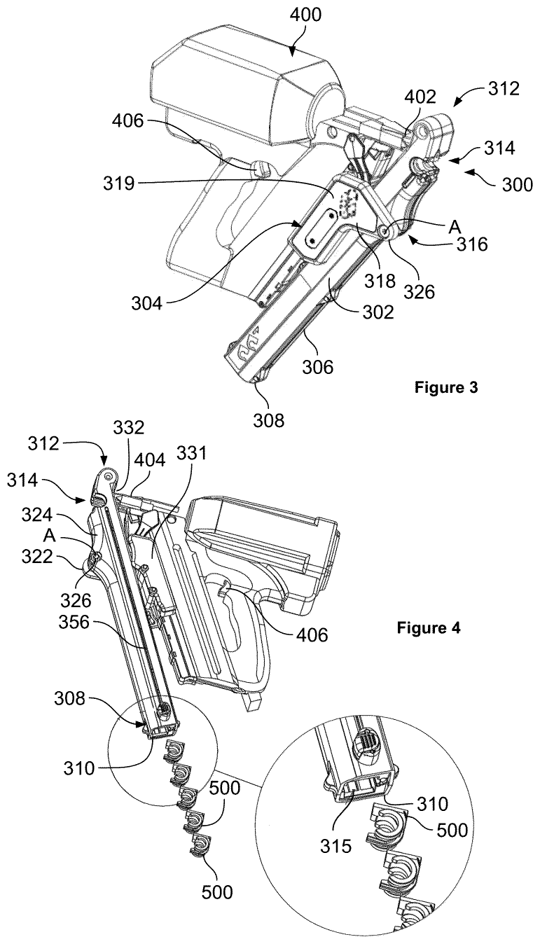

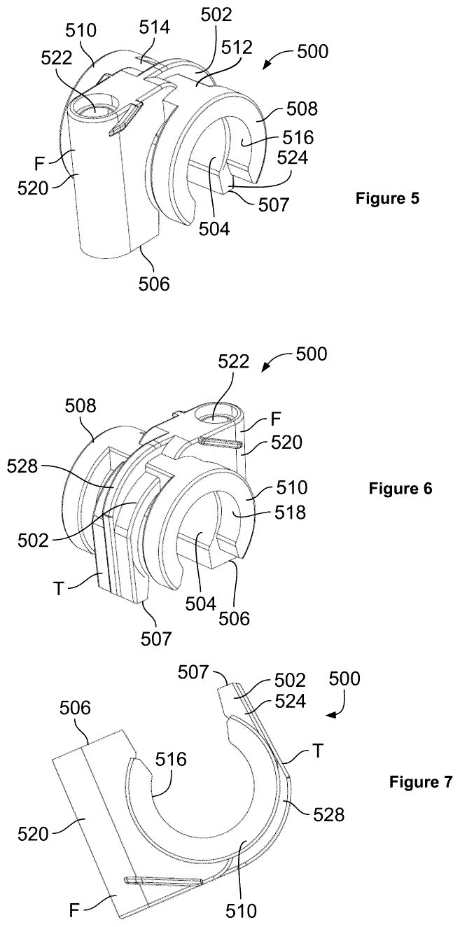

FIGS. 3 and 4, and 12 to 26 illustrate an embodiment of a pipe clip dispensing device in accordance with one embodiment of the present disclosure. FIGS. 5 to 11 illustrate clips for use in the clip dispensing device.

In the figures reference numeral 300 refers generally to the pipe clip dispensing device.

Referring in particular to FIGS. 3 and 4, the pipe clip dispensing device 300 comprises a pipe clip cartridge 302 for holding a plurality of pipe clips. The pipe clip cartridge 302 is, in use attached to a fastener gun, which in the illustrated embodiment is in the form of nail gun 400, via a fastener gun mounting, generally designated 304. The pipe clips, as illustrated in FIGS. 5 to 11 are generally designated 500.

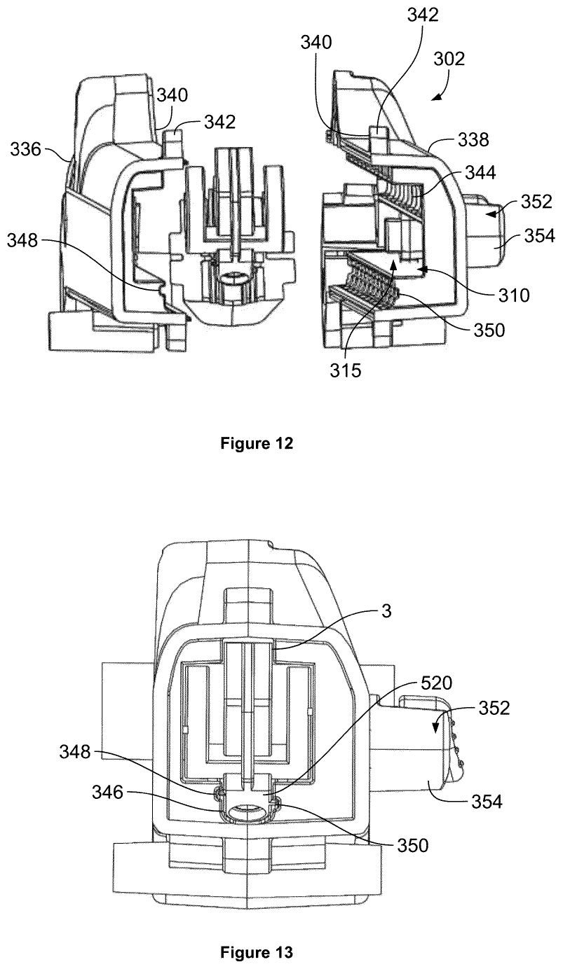

The pipe clip cartridge 302 comprises an elongate body 306, having a first end 308 which provides a clip inlet 310 for a user to insert pipe clips into the pipe clip cartridge 302, and a second end 312 with a clip outlet. Provided close to the second end 312 is a pipe clip positioning region 314 for holding and positioning a pipe clip so that that it can be mounted on a pipe. A clip path in the form of a clip feed track 315 (shown in, for example, FIGS. 4 and 12) extends between the clip inlet 310 and the pipe clip positioning region 314.

The attachment of the pipe clip positioning region 314 to the fastener gun mounting 304, is configured so that the pipe clip positioning region 314 of the cartridge 302 can be moved towards and away from a fastener delivery part 402 of the nail gun 400. The fastener delivery part 402 is the nose or muzzle of the nail gun 400, from which nails are discharged and driven into a workpiece. In use the fastener gun mounting 304 does not move relative to the nail gun 400.

In the illustrated embodiment the pipe clip cartridge 302 is connected to the fastener gun mounting 304 by a pivot arrangement 316, which provides an axis of rotation A which is spaced apart from the pipe clip positioning region 314. The fastener gun mounting 304 provides a first projecting support portion 318 which is part of a first-side part 319 of the fastener gun mounting 304. The first projecting support portion 318 projects forwardly (that is, generally in the fastener driving direction of the nail gun 400) relative to the nail gun 400. A first part of the pivot arrangement 316 is, in this embodiment, provided by a first pivot aperture 320, provided at an end region 322 of the first projecting support portion 318 which is distal from the nail gun 400.

The pipe clip cartridge 302 provides a second projecting support portion 324 on a side thereof which is, in use, distal from the nail gun 400. A second part of the pivot arrangement, which in this embodiment is provided by a second pivot aperture 326, is provided at an end region 328 of the second projecting support portion 324. In use the first and second pivot apertures 320, 326 are aligned and a pivot pin, for example in the form of a bolt 330 extends through both of the pivot apertures 320, 326 thus providing the pivot arrangement between the pipe clip cartridge 302 and the fastener gun mounting 304.

As illustrated in FIG. 4, the pipe clip cartridge 302 is configured to receive a plurality of pipe clips 500, which may conveniently be provided a line or string 1000 of linked pipe clips, and to feed the pipe clips sequentially from the clip inlet 310, along the clip path and clip feed track 315, to the pipe clip positioning region 314 as foreshadowed above, and as will be described in more detail in due course. FIG. 4 also shows a second-side part 331 of the fastener gun mounting 304.

The nail gun 400 includes a safety mechanism comprising a work contact element 404, adjacent the fastener delivery part 402, for contacting a work surface. The work contact element 404 is biased to a forwardly extended position, but can be moved, against the bias force, to a retracted position by contact with a work surface. The safety mechanism prevents operation of the nail gun 400 when the work contact element 404 is in the forwardly extended position, and allows operation of the nail gun by a user, by operation of a trigger 406 of the nail gun, when the work contact element 404 is moved into the retracted position. Such safety mechanisms are common on commercially available nail guns, and well known.

One advantage of allowing the pipe clip positioning region 314 to move towards and away from the fastener delivery part 402 of the nail gun 400 is that a contact part 332 of the pipe clip cartridge may be brought to bear against the work contact element (to allow operation of the fastener gun) when the user wishes to operate the fastener gun, and also allows the pipe clip 500 in the pipe clip positioning region 314 to be mounted on (e.g. clipped onto) a pipe while the positioning region of the pipe clip cartridge 302 is relatively far from the fastener delivery part 402 and the work contact element 404 of the nail gun 400, so that the safety mechanism is operative and the fastener gun 400 cannot be operated, maintaining safety.

Another advantage of allowing the pipe clip positioning region 314 to move towards and away from the fastener delivery part 402 of the nail gun 400 is considered that it facilitates provision of an opening of the fastener passage of the pipe clip at or close to the leading end of the fastener prior to its delivery, which reduces the likelihood of misalignment of the fastener passage and fastener. The specific structure and further features of the described embodiment will be described in due course.

FIG. 3 also shows schematically, in broken lines, a rotation limiting arrangement for limiting the angular extent to which the pipe clip cartridge 302 may pivot relative to the fastener gun mounting 304, comprising an arcuate groove in an inwardly facing wall of the first-side part 319 of the fastener gun mounting 304, and a corresponding projection provided on the pipe clip cartridge 302, the projection being received within the groove, so that the angular movement of the pipe clip cartridge 302 is limited by the movement of the projection being angularly limited between first and second ends of the groove.

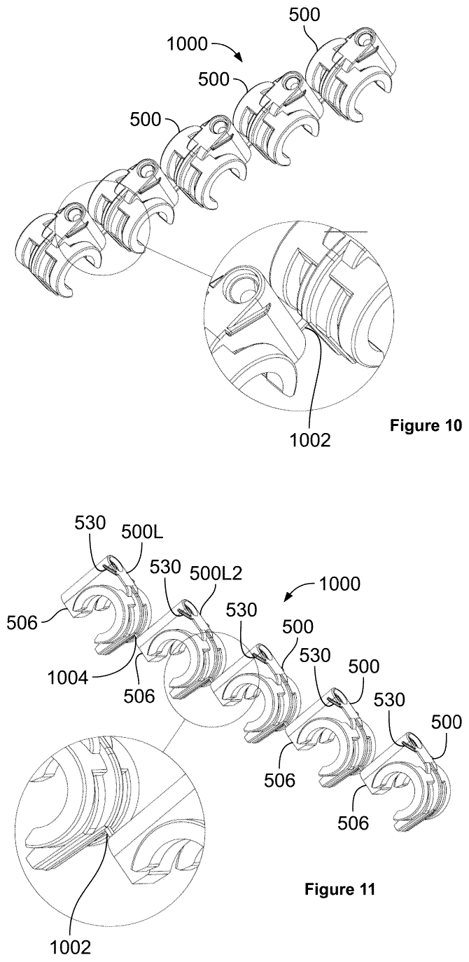

The string of pipe clips and the structure of individual pipe clips is shown in some detail in FIGS. 5 to 11. FIGS. 5 to 9 show different views of an individual clip 500. FIGS. 10 and 11 illustrate a string or line 1000 of connected clips 500.

Referring to FIGS. 5 to 9, each clip 500 comprises a body 502 that defines a first curved or arcuate, part circular, pipe receiving recess 504 having a first effective radius of curvature that makes it suitable for effectively holding a pipe of a first, larger, diameter.

The body 502 has opposed base parts 506, 507, spaced from the first pipe receiving recess 504 so that a circular cross section pipe held in the first pipe receiving recess 504 will be spaced from a support surface. This may protect the pipe surface and support surface from damage caused by abrasion therebetween.

The clip 500 further comprises two curved or arcuate arms 508, 510 spaced laterally on either side of body 502 by means respective links 512, 514. Each arm 508, 510 defines a second curved pipe receiving recess 516, 518, on a respective side of the first pipe receiving recess 504, having a second smaller, radius of curvature. The effective diameter of the second pipe receiving recesses 516, 518 is less than that of the first pipe receiving recess 504. However, it is also able to grip and hold a smaller 16 mm diameter pipe.

In use, the first pipe holding recess 504 in the body 502 may accommodate a larger diameter, for example a 20 mm, pipe. The second effective diameter of the second pipe receiving recesses may accommodate a smaller diameter, for example 16 mm pipe. If the clip is used with a larger diameter pipe the arcuate arms 508, 510 are deformed outwardly, allowing the larger diameter pipe to be accommodated in the first pipe receiving recess 504. However, it is also able to grip and hold a small 16 mm pipe.

The body 502 may be regarded as having two ends, that for convenience are referred to as the trailing T and forward F ends in the direction of travel from clip inlet 310 of the clip cartridge 302 to the pipe clip positioning region 314. The forward end F of the clip 500 comprises a clip post in the form of a first support part 520 with a curved inner wall that defines one side of the first pipe receiving recess 504. A fastener passage in the form of a linear bore 522 extends through the first support part 520 to allow a fastener to pass therethrough.

The trailing end T of the body 502 is defined by a second support part 524 with a curved inner wall that defines the other side of the recess 504. An outer surface 526 of the second support part 524 has a reinforcing rib 528.

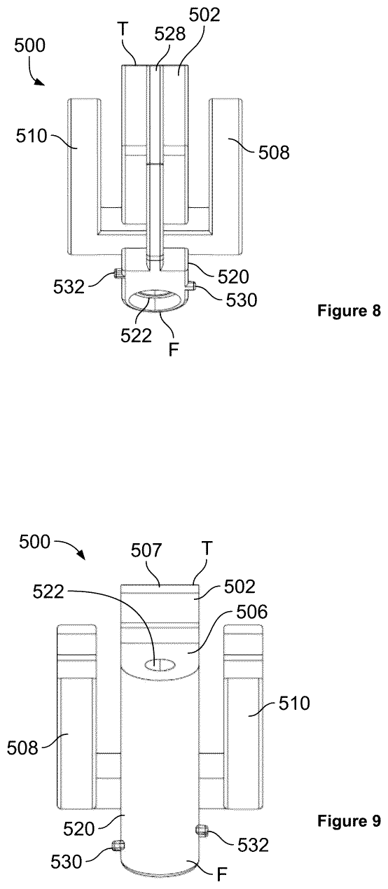

The clips 500 further comprise clip guide formations in the form of alignment projections or ribs 530, 532 on the upper external part of first support part 520. The ribs 530, 532 are angled in the trailing direction. FIGS. 8 and 9 illustrate the feature where one rib 530 is placed further towards the upper (or fastener entry) end of the first support part 520 than the other rib 532. In use the ribs 530, 532 cooperate with complementary clip guiding formations in the form of clip guide and alignment tracks (to be described in due course, with reference to FIGS. 12 and 13) in the pipe clip cartridge so as to guide the clips 500 and keep them properly aligned within the clip feeding track 315 in the pipe clip cartridge 302. The asymmetric positioning of the ribs 530, 532 helps prevent the clips 500 from being inadvertently loaded into the pipe clip cartridge 302 in an incorrect orientation, e.g., back to front. (As described, the clip guide formations of the pipe clip 500 are in the form of ribs 530, 532 or other projections which are configured to cooperate clip guiding configurations in the form of tracks or grooves in the pipe clip cartridge 302, but it should be understood that in an alternative one or more of the clip guide formations on the pipe clip may comprise grooves or other recesses and one or more complementary clip guiding formations of the cartridge may comprise ribs or other projections.)

FIGS. 10 and 11 show different views of a line or string 1000 of five clips 500 connected together by breakable connection elements 1002. As best seen in FIG. 11, the clips 500 are aligned in a “slanted” or “stepped” configuration in that the respective base or bottom surface parts 506, 507 of respective clips are not coplanar or colinear, since the cartridge of the device 300 is non-orthogonal to the fastener driving direction of the fastener gun.

However, corresponding ribs 530, 532 of the respective clips 500 are substantially colinear, as they are all aligned to be received in alignment tracks in the pipe clip cartridge.

The trailing section of a leading clip 500L, that is the clip that is fed first into the magazine, is frangibly connected to the next clip by a breakable or frangible tab or link 1004 that extends rearwardly from about half way up the second, or trailing end, support part 524 to the lower part of the first (post) support 520 of the adjacent second clip 500L2. The second clip 500L2, and each subsequent clip 500, is connected to the next adjacent clip 500, in the same manner, to provide the line or string 1000 of clips.

In an embodiment the breakable or frangible tab or link 1004 is configured so that, in use, it breaks at or close to the leading clip (for example 500L) of each pair of adjacent pipe clips 500 so that at least some of the tab is left attached to the following clip (for example 500L2), as a small projection at the leading end thereof. The small projection may be used to help accurately position the following clip in the pipe clip positioning region 314, as will be described in due course. The tab or link 1004 may, for example be smaller in cross sectional size where (or close to where) it connects to the leading clip (for example 500L) of each pair of adjacent pipe clips 500. In an embodiment each tab or link 1004 is tapered, from a larger (cross sectional) size, closer to the following clip of the pair of adjacent pipe clips which is connected, to a smaller (cross sectional) size, closer to the leading clip of the pair of adjacent pipe clips which is connected.

The line or string 1000 of clips may be integrally formed, for example by an injection moulding process, and may be formed from a suitable thermoplastic material such as polyethelene, polypropylene or copolymers thereof.

The clips and frangible connections may be formed in a single moulding_process, for example injection moulding. However, it will be appreciated that a number of other processes may equally be used. For example, the clips 500 may be separately formed and the breakable connections such as tabs may be provided subsequently, for example by melt welding or extrusion of a suitable adhesive or other suitable settable material onto a line of pre-aligned clips. In this way the material of the frangible connections may be different from that of the clips. This may have some advantages in addressing an apparent compromise between the desired degree of resilience of the clips to support a pipe and the required degree of frangibility.

In yet another embodiment that has not been illustrated, the clips may be formed with a mechanical interlock system, such as for example a dovetail, or dovetail-like connection that is designed to withstand the forces of movement through the cartridge but will disconnect upon driving of a fastener through the fastener passage of a clip, and/or on relative movement of adjacent pipe clips in a predetermined direction. This may allow a user an option of using a preferred length of clips.

Further, although the use of a string of clips is considered desirable, as it is considered to facilitate and ease loading of clips into the cartridge and also generally the handling of a plurality of clips a series of individual clips may also be used.

In use, the clips 500 are fed through the cartridge along the clip path and the clip feed track 315 by a biasing mechanism (not shown) which in the illustrated embodiments comprises a flat coil “clock spring” which operates similarly to the mechanism used to retract retractable tape measures. This is well known in the art due to its close correspondence to the biasing mechanism used to feed nails through nail magazines of commercially available nail guns.

FIG. 12 shows an exploded slightly angled end view of the clip inlet 310 of the clip cartridge 302, illustrating the clip feed track 315 and a clip 500 in the clip feed track 315. FIG. 13 shows an assembled end view, again with a clip 500 in the clip feed track 315.

As can be seen in FIGS. 12 and 13, the part of the pipe clip cartridge 302 which provides the clip feed track 315 is provided by first and second side parts 336, 338, which are connected together in use, for example by screws or bolts (not shown) which extend through apertures 340, in small projections 342 on the outsides of the first and second side parts 336, 338.

The cross sectional shape of the clip feed track 315 corresponds generally to the shape of the pipe clips 500. The various main parts of the device 300, including the first and second side parts 336, 338 may be made by injection moulding of a suitable plastic. To avoid undue weight and material usage the interiors of the main components may include web structures or this like, as indicated by the parallel webs 344 shown in FIG. 12. Apart from weight and material saving these are not considered to have any substantial effect on the function of the device.

Notably, as can be seen in FIGS. 12 and 13, the clip feed track 315 is configured to provide a recess 346, which accommodates the upper part of the first support part 520 of each pipe clip. Within the wall of the recess 346, two additional elongate recesses are provided, which provide clip guiding and alignment formations 348, 350 which accommodate the ribs 530, 532 of the clips 500. As can be seen in FIGS. 12 and 13, the clip guiding formations 348, 350 are configured asymmetrically in the recess 346, consistent with the asymmetric arrangement of the ribs 530, 532 on the clips 500. As noted above, this asymmetric configuration helps prevent the clips 500 inadvertently being loaded into the pipe clip cartridge 302 in an incorrect orientation, e.g. a reverse or back to front orientation.

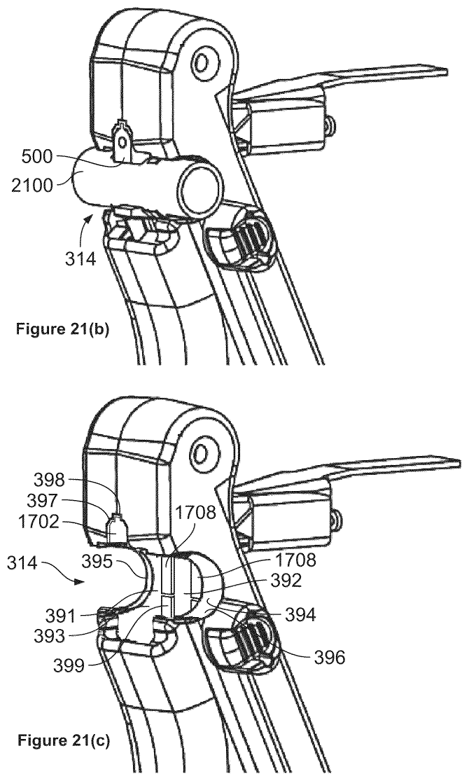

FIGS. 12 and 13 also show a manually operable control 352 of the biassing mechanism used to progressively feed the clips through the pipe clip cartridge 302. The manual control comprises a knob 354, moveable along on the outside of the clip cartridge along the clip feed track 315. A pushing member, not shown, normally located so that it extends into the clip feed track 315 is connected to the knob through a slot 356 in the wall of the clip cartridge, and pushes the trailing clip to bias the plurality of pipe clips 500 in the direction towards the positioning region 314. (The knob 354 and slot 356 are shown in FIGS. 4 and 21(a)). Close to the inlet end of the clip feed track 315 the slot provides a widened part 357 (FIG. 21(a)), which allows movement of the pushing member laterally out of the clip feed track 315, although it remains captured within the interior of the pipe clip cartridge 302. With the pushing member clear of the clip feed track 315, additional clips may be fed into the clip feed track 315 via the clip inlet 310. When desired the pushing member may be returned to the clip feed track 315 by depressing a button provided on the knob 354. This also allows the pushing member to move under the bias force of the spring, to apply a pushing or advancing force to the pipe clips. As stated previously, this type of mechanism is used in commercially available nail guns (such as, for example, the PASLODE IMPULSE 30 (trademarks)) to bias nails in the nail magazine.

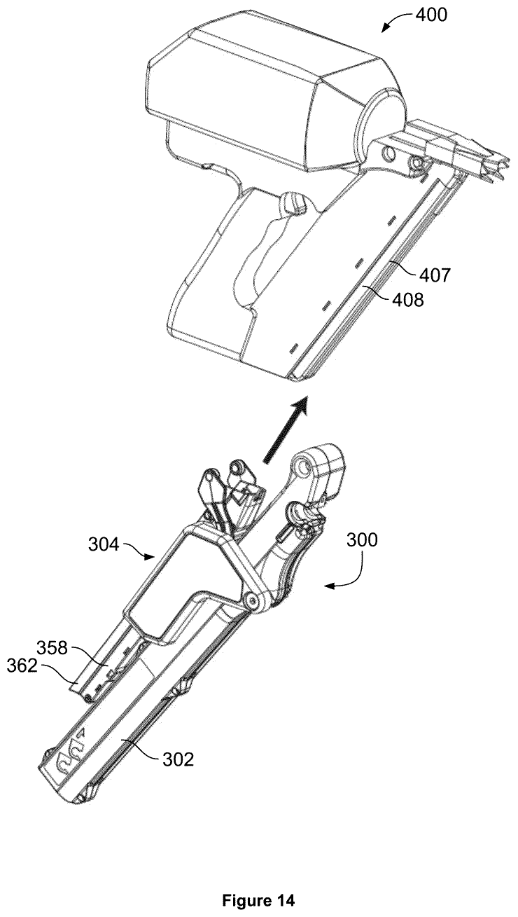

It will be appreciated that the pipe clip dispensing device of the described embodiments is used in combination with a fastener gun on which the pipe clip dispensing device is releasably mounted. FIG. 14 illustrates an example of attachment of the pipe clip dispensing device 300 to a fastener gun that is a nail gun 400. The nail gun is a piece of equipment that is widely used in the building and the plumbing arts and which can be purchased off the shelf. It is typically used to drive nails into timber when constructing a stud and plate frame for a building such as a residential home. Examples of suitable nail guns include a PASLODE IMPULSE 30 and a PASLODE Li-ion and fuel gun that are both widely used by tradespeople in Australia. (It should be appreciated that the present disclosure is applicable to fastener guns other than nails guns and that other types of fastener guns, such as for example fastener guns which use fasteners in the form of screws, may use a work contact element at or adjacent a fastener discharge part of the fastener gun, to control operation of the fastener gun.)

Broadly a nail gun may comprise a gun body having a nail cartridge extending transversely (orthogonally or ‘slanted’) away from the body, and a handle with a trigger also extending at an angle from the body.

The gun further comprises a nail firing arrangement at a front end of the gun for firing a nail out of the gun into a workpiece when the trigger is pulled. The nail firing arrangement has a safety feature for preventing the gun from firing a nail unless it is pressed firmly against a workpiece. The safety feature comprises a safety plate that is spring loaded towards a forward position and that needs to be retracted backwards to unlock the safety feature and arm the gun. Typically, this is done when a leading end of the gun including the nail firing arrangement is pressed against a work piece with sufficient force to overcome the spring loading and retract the safety plate.

As shown in FIG. 14 the clip dispensing device 300 as a whole (including the pipe clip cartridge 302 and the fastener gun mounting 304, pivotally coupled together) may be attached to a nail gun by sliding a suitably dimensioned and shaped channel member 358 onto a front part of the nail gun 400 which provides a rail-type attachment configuration 407, in this example including grooves 408. The channel member 358 is part of the fastener gun mounting 304 and provides a front panel part 360 and first and second opposed side panel parts 362, 364 which extend substantially perpendicularly to the front panel part, from opposite long edges of the front panel part 360. The side panel parts 362, 364 provide inwardly depending projections (not shown) complementary to, and able to be received in, the grooves 408.

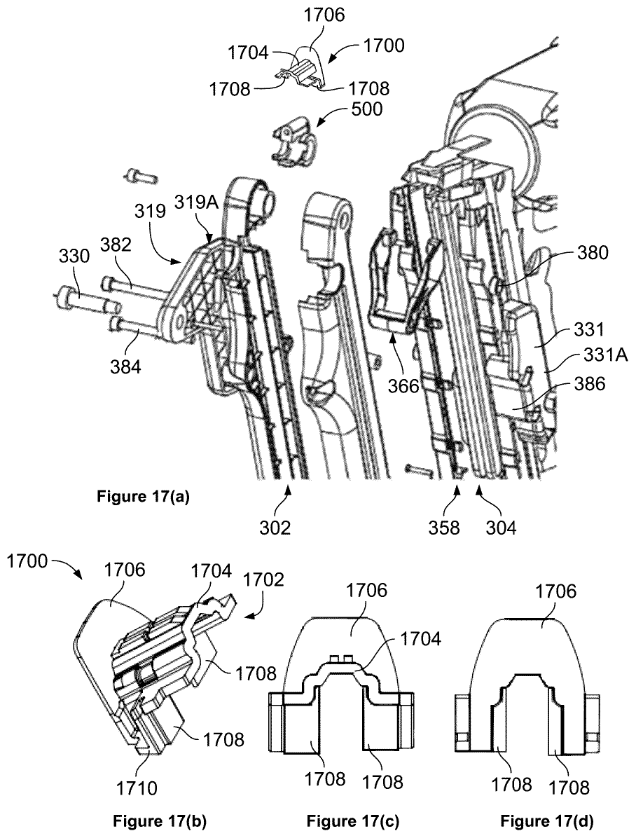

The channel member 358 can slide along the rail-type attachment configuration 407 of the nail gun 400 to position the device 300 on the nail gun, and can then be secured in position. The channel member 358 may be secured to the nail gun 400 by any suitable securing arrangement. By way of example, in the illustrated embodiment the channel member 358 is securable to the rail part by providing an inwardly directed force on each of the two opposed side panel parts 362, 364, to thereby effectively clamp a part of the rail-type attachment configuration 407 of the nail gun 400 between the two opposed side panel parts of the channel member 358. This will be described in more detail in due course, with particular reference to FIG. 17.

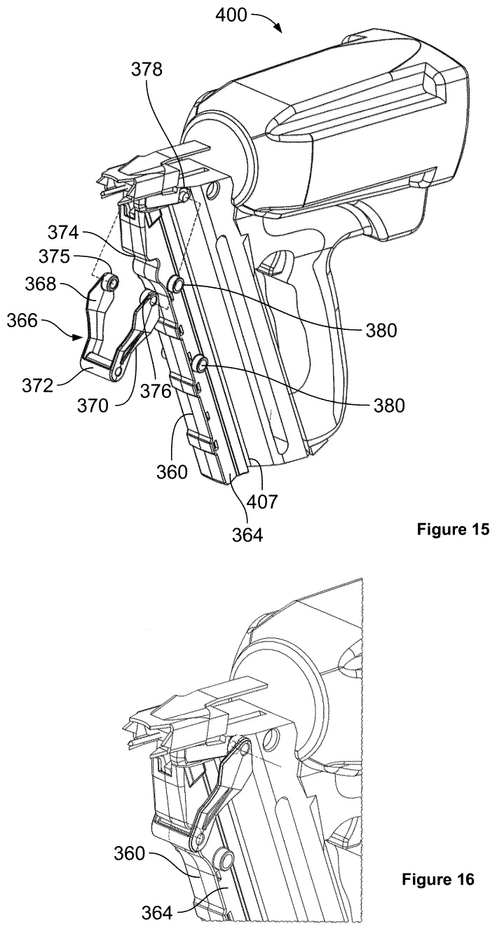

FIGS. 15 and 16 show the channel member 358 mounted on the rail-type attachment configuration 407 at the front of the nail gun 400. The first and second-side parts 319, 331 and the pipe clip cartridge 302 are omitted from FIGS. 15 and 16 so that the channel member 358 can be more fully shown.

As illustrated, the fastener gun mounting 304 further comprises a spacing member, which in this embodiment is in the form of a yoke member 366. The yoke member 366 comprises first and second arms 368, 370. First ends of each arm 368, 370 are connected by a cross member 372, which is adapted to engage with an engagement groove 374 provided near the top of the front panel part 360 of the channel member 358. Second ends of each arm 368, 370 are provided with attachment parts 375, 376 for attaching to respective predetermined features on opposed sides of the nail gun 400. In the illustrated embodiment the attachment parts 375, 376 are friction fit cups, configured to fit over, and attach by friction fit to, screw heads 378, provided on opposed sides of the nail gun 400. In a variation the attachment parts 375, 376 may be projecting lugs, configured to fit into and attach by friction fit within, screw holes, provided on opposed sides of the nail gun 400.

Use of the yoke member 366 facilitates correct positioning of the channel member 358 and thus the fastener gun mounting 304 as a whole, on the nail gun 400. That is, the yoke member 366 can only be fitted in position, with the cross member 372 engaging the engagement groove 374 and the attachment parts 375, 376 attached to the respective predetermined features on opposed sides of the fastener gun 400, when the channel member 358 is in the correct position along the rail system of the nail gun. (It will be appreciated that if the channel member is not in the correct position along the rail system of the nail gun, the pipe clip cartridge 302 will not be positioned correctly to align the fastener passages of the pipe clips 500 with the fasteners delivered by the nail gun 400.)

FIG. 17 shows various components of the fastener gun mounting 304 including the channel member 358 mentioned above.

As mentioned above, the fastener gun mounting 304 includes the first-side part 319 of the fastener gun mounting 304 and the second-side part 331 of the fastener gun mounting 304, which are, in this embodiment, formed as parts separate to the channel member 358. The first-side part 319 and the second-side part 331 of the fastener gun mounting 304, in use, each provides at least a respective rear part thereof 319A, 331A, laterally overlying and abutting the respective first and second side panels of the channel member 358. The side panels of the channel member 358 include engaging formations 380 (shown best in FIG. 15), for example projections, which may be circular. The engaging formations 380 engage complementary engaging formations (not shown) located on laterally inward sides of the rear parts 319A, 331A of the first-side part 319 and the second-side part 331, so that the relative positions of the channel member 358 and the first- and second-side parts 319, 331 are fixed. Thus, in use, the position of the pivot axis A is fixed relative to the channel member 358. The engaging formations (not shown) located on the laterally inward sides of the first- and second-side parts 319, 331 may be recesses complementary to, and configured to receive, the projections which in this example form the engaging formations 380. The first- and second-side parts 319, 331 may be connected by one or more threaded rods, such as bolts 382, 384, just in front of the channel member so that they can be forced together, thus applying laterally inward forces to the first and second side panels of the channel member 358, effectively clamping part of the rail system of the nail gun 400 therebetween, and locking the channel member 358, and thus the rest of the fastener gun mounting 304, in a desired position on the nail gun. In the illustrated embodiment each of the first- and second-side parts 319, 331 is provided with a rod guide 386, at a fixed angle relative to the first- and second-side parts 319, 331. In the illustrated example the rod guides are perpendicular to the main parts of the first- and second-side parts 319, 331. The rod guides 386 of the first- and second-side parts 319, 331 abut substantially at the lateral centre of the fastener gun mounting 304, just in front of the channel member 358. The rod guides 386, and the overall stiffness of the first- and second-side parts 319, 331 ensures that the first- and second-side parts 319, 331 do not twist substantially as they are drawn together by the bolts 362, 364, which could compromise the clamping of the channel member 358.

FIG. 17(a) also shows an insert 1700 of resilient material, such as a hard-wearing rubber, for example TPU or TPE (and in an embodiment, for example, thermoplastic elastomer (TPE) with a hardness around 80 Shore A), which in use is located in, and forms part of, the pipe clip positioning region 314 of the pipe clip cartridge 302, and which will be described in due course.

FIGS. 17(b), 17(c) and 17(d) are, respectively, enlarged perspective, front and rear views of the insert 1700.

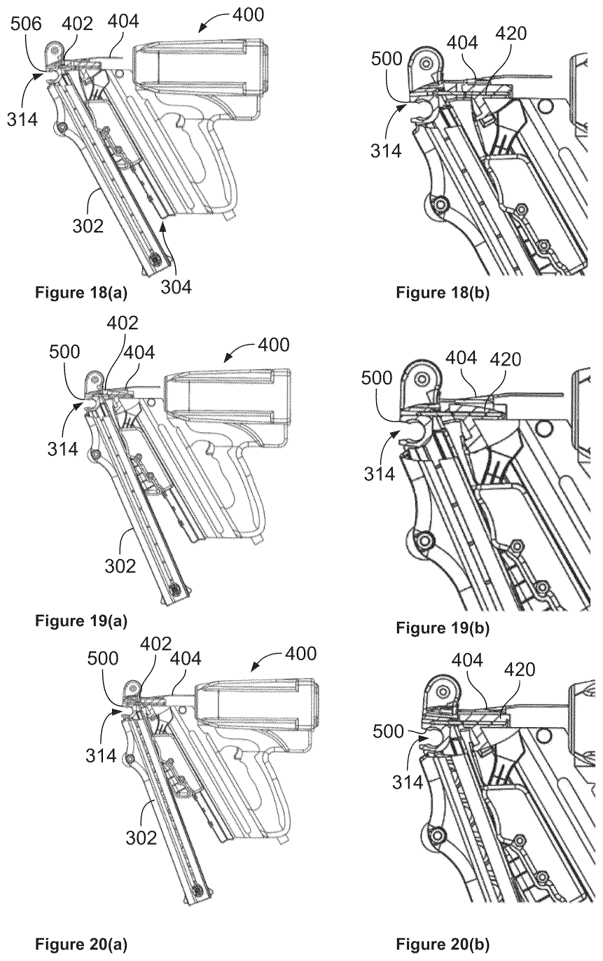

FIGS. 18(a), 19(a) and 20(a) are schematic partial cross sectional views, from the second side, of the pipe clip dispensing device 300 illustrating progressive movement of the pipe clip positioning region 314, in this case by pivoting of the pipe clip cartridge 302 relative to the fastener gun mounting 304 and thus the fastener gun 400. More specifically, FIGS. 18(a), 19(a) and 20(a) illustrate, sequentially, movement of the pipe clip positioning region 314 towards the fastener delivery part 402 of the nail gun 400.

FIG. 18(a) illustrates the device 300 with the pipe clip positioning region 314 at a maximum distance from the fastener delivery part 402. In this position the pipe clip 500 in the pipe clip positioning region 314 may be mounted on a pipe safely, as the work contact element 404 of the nail gun 400 is in a forward, extended position, so that the safety mechanism of the nail gun 400 is operative and the gun cannot be operated.

FIG. 19(a) illustrates the device 300 with the pipe clip positioning region 314 at an intermediate distance from the fastener delivery part 402, representing a position after mounting of the clip on a pipe, but prior to desired operation of the nail gun 400. In this position the work contact element 404 of the nail gun 400 is in an intermediate position, but is not fully retracted, so the safety mechanism of the nail gun is still operative and the nail gun 400 still cannot be operated.

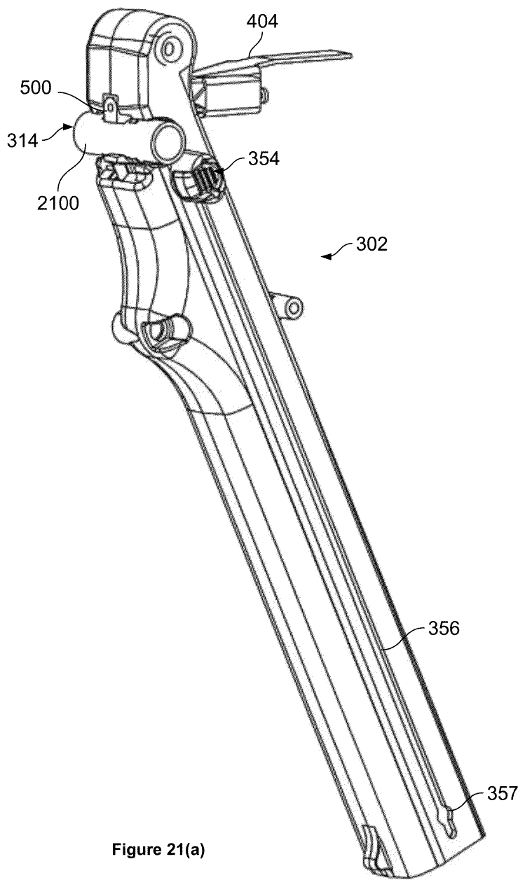

FIG. 20(a) illustrates the device 300 with the pipe clip positioning region 314 at a minimum distance from the fastener delivery part 402, representing a position after mounting of the clip on a pipe, and when the user wishes to operate the nail gun 400. In this position the pipe positioning region 314, has been moved sufficiently close to the fastener delivery part 402 of the nail gun 400 that a contact region 390 at a rear of the pipe clip cartridge 302, at or adjacent the pipe positioning region 314, has engaged and pressed against the work contact element 404 of the nail gun 400, so that the work contact element has been pushed into a retracted position. In this position the safety mechanism of the nail gun 400 is inoperative and the nail gun 400 can be operated to drive a fastener through the fastener passage of the pipe clip 500, to fasten the pipe clip 500 and the part of the pipe upon which the pipe clip is mounted, to a work surface such as, for example, a wall of a building.

FIGS. 18(b), 19(b) and 20(b) are enlargements of the upper part of the device 300, including the pipe clip positioning region 314, of FIGS. 18(a), 19(a) and 20(a) respectively.

By way of schematic example, the position of a nail at the fastener delivery part 402 (prior to operation of the nail gun) is illustrated by the solid black line 420. It will be appreciated that as the pipe positioning region 314 is moved progressively from the position shown in FIG. 18(b) to the position shown in FIG. 20(b) the pipe clip 500, and the entry opening of the fastener passage of the pipe clip 500, is move progressively towards the leading (forward) end of the nail 420. In an embodiment (and depending, at least in part on the fastener position prior to operation of the fastener gun) the pipe clip 500 may be moved sufficiently towards the fastener delivery part 402, that the leading (forward) end of the nail 420 is very close to, or even partially inserted into, the fastener passage of the pipe clip 500, prior to operation of the nail gun, as illustrated schematically in FIG. 20(b).

FIG. 21(a) illustrates the pipe clip cartridge 302, and the work contact element 404 of the safety mechanism of a nail gun 400, illustrating a pipe clip 500 in the pipe clip positioning region 314 of the cartridge, clipped onto a pipe 2100.

FIG. 21(b) is an enlargement of the upper part of FIG. 21(a) including the pipe clip positioning region 314, pipe clip 500 and pipe 2100, illustrating further detail.

As can be seen in FIG. 21(c), the pipe clip positioning region 314, provides an exit aperture 391 at the front of the pipe clip cartridge 302 (that is, the part which extends furthest in the fastener driving direction) from which pipes clips exit the pipe clip cartridge in normal use. In use the leading clip is retained in a clip holding space 392 within or just behind the aperture 391. The sides of the aperture are provided by side wall portions 393, 394 which define arcuate cut-outs 395, 396, so that a pipe can be accommodated thereby, and so that a pipe clip held in the pipe clip mounting space can be mounted on the pipe while the clip is retained in the holding space 392. The upper edge 397 of the aperture is configured with a shape complementary to a part of the pipe clip 500 that it contacts. In the illustrated embodiment the upper edge 397 is shape to be complementary to the shape of a support post of the clip 500, such that when the support post of the clip 500 is fitted to the complementary shape of the upper edge 397, the contacting part of the support post is correctly positioned for fastening by a fastener driven by the fastening gun (nail gun 400). The shape of the upper edge 397 includes a small notch part 398 for receiving a part of a tab that is left on a trailing clip, as discussed above.

The insert 1700 of resilient material (shown schematically and separately in FIGS. 17(a) to 17(d)) is provided adjacent the aperture 391. A pipe clip positioning part 1702 of the insert 1700 is in the form of a half-tube or arching passageway roof 1704, which extends between the exit aperture 391 and a fastener entry aperture in the rear side of the pipe clip positioning region 314, at or close to where the forwardmost part of the work contact element 404 is shown in the drawings. The cross sectional shape of an engagement part of the clip positioning part 1702 corresponds generally to the shape of the upper edge 397 of the exit, and is configured to abut, position and orient the post of a pipe clip 500, suitably for a fastener to be driven through the fastener passage (provided in the post of the clip 500) by the nail gun 400.

Where the insert 1700 exits the rear aperture it extends outwardly away from the rear aperture on the adjacent surface of the pipe clip cartridge 300 to provide a cover 1706 for the contact part 332 of the pipe clip cartridge 302 to provide a high friction contact surface for the work contact element 404 of the nail gun 400 and/or to help prevent damage to the contact part 332 by the work contact element which may be (and, in some commercially available nail guns, is) provided with one or more points at its forward end.

The insert 1700 also helps provide a clip holding arrangement for helping to resiliently hold pipe clips in the pipe clip holding space 392. The holding arrangement is provided by flexible flaps or wings 1708 provided by the insert 1700, which offer resistance to passage of the guide formations of the pipe clips 500 past the flaps or wings. More specifically, and as shown in FIG. 21(c), the substantially rigid formations 399 which provide the clip guiding and alignment formations 348, 350 along most of the length of the clip feed track 315, terminate at the pipe clip holding space 392, and instead the resilient wings or flaps 1708 of the insert are provided. The resilient wings or flaps 1708 retain the alignment projections or ribs 530, 532 in a similar manner to provide clip guiding and alignment formations 348, 350, except that, being formed of a resilient material, they can be displaced out of the way of the pipe clips 500, for example by movement of the device 300 away from a clip 500 that has been fixed to a support by a fastener. The insert 1700 may further include one or more clip or abutment parts 1710 (illustrated in FIG. 17(b)) which oppose parts of the cover 1706 part of the insert for holding a wall of the pipe clip cartridge 302 therebetween, so assist in locating the insert 1700 in the pipe clip cartridge 302. (The clip or abutment parts 1710 are omitted from FIGS. 17(c) and 17(d) for clarity.)

Thus the clip holding arrangement is able to retain pipe clips 500 in the pipe clip holding space 392, but allows the clips to be removed (for example by movement of the device 300 away from a clip 500 that has been fixed to a support by a fastener) as desired.

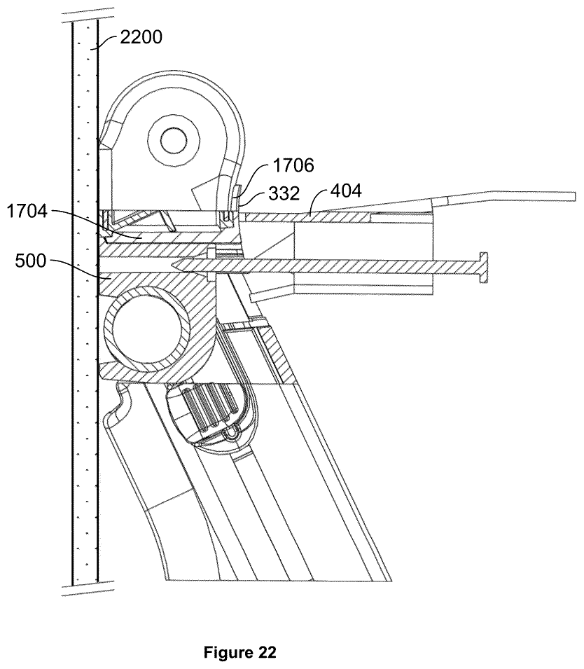

FIG. 22 is a cross sectional view corresponding generally to FIG. 21(b) and also showing a wall 2200 (or other work surface) to which the pipe clip 500 and pipe are to be fixed by a fastener.

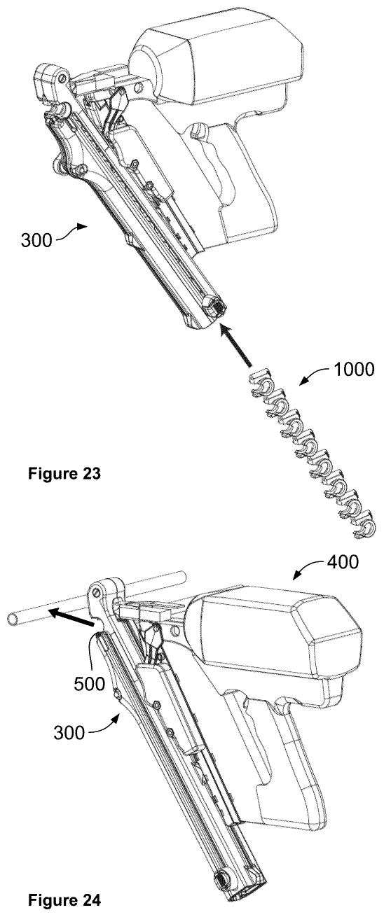

FIG. 23 illustrates the pipe clip dispensing device 300 attached to the nail gun 400, with the biassing mechanism for biassing the clips in a loading position and with a string of clips 1000 being inserted into the pipe clip cartridge.

FIGS. 24 to 26 illustrate sequentially use of the pipe clip dispensing device 300 in combination with a nail gun 400, for mounting fixing a pipe to a support, such as a wall (not shown).

FIG. 24 shows the pipe clip dispensing device 300, mounted to the nail gun 400, with a pipe clip 500 in the pipe clip holding space 392, being moved towards a pipe which it is desired to fix to a support.

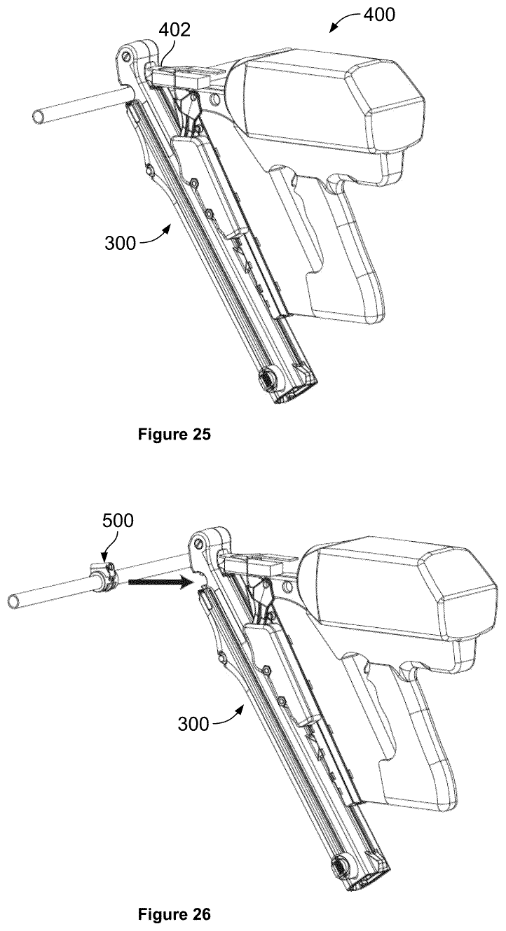

FIG. 25 shows the pipe clip dispensing device 300 being pushed towards the pipe so that the pipe clip 500 in the pipe clip holding space 392 is mounted on the pipe, and so that the pipe positioning region can be brought closer to the fastener delivery part 402 of the nail gun 400. Then the work contact element 404 is retracted (as previously described) and the nail gun 400 operated to drive a fastener through the fastener passage of the pipe clip and into the support, thus securing the pipe clip and pipe to the support.

FIG. 26 shows movement of the pipe clip dispensing device 300 and nail gun 400 away from the secured pipe clip 500 and pipe. This allows the clip to exit the pipe clip holding space 392, and causes the tab connecting the clip to the next clip in a string of clips to break. The next clip 500 in the cartridge 302 is then moved to the pipe clip holding space 392 by the biassing mechanism previously described. The process illustrated in FIGS. 24 to 26 may then be repeated, to secure different parts of the pipe or different pipes, as desired.

It will be appreciated that many variations are possible. For, example, although the above description refers to the use of strings or lines of connected clips 500, this does not preclude that separate clips may be used (and, for example, inserted individually into the pipe clip magazine 302).

Further, although the illustrated embodiment shows pipe clips which have different pipe retaining formations configured for retaining respective different diameters of pipe, the disclosure is also applicable to pipe clips having a single pipe retaining formation (that is, for example, of the same general type as shown in FIG. 1, although guide formations not present in the clip of FIG. 1 may beneficially be included).

Further, although the above described embodiment uses a pivoting coupling arrangement between the pipe clip cartridge and the fastener gun mounting to facilitate the positioning region being moveable towards and away from the fastener delivery part of the fastener gun, other types of coupling arrangement could be used. For example, the pipe clip cartridge could be arranged to slide backwards and forwards relative to the fastener gun mounting (for example on rods coupled to each of the pipe clip cartridge and fastener gun mounting).

Further, while the described embodiment is configured to be biased towards the configuration in which the pipe clip positioning region is distal from the fastener delivery part of the fastener gun by contact with the forwardly biased work contact element of the fastener gun, a variation may include an alternative or additional arrangement for biasing the pipe clip positioning region in a direction away from the fastener delivery part of the fastener gun, such as, for example, a spring, optionally a torsion spring, at or close to the pivotal connection between the pipe clip cartridge and the fastener gun mounting.

Further, while the described embodiment provides a fastener gun mounting which is retro-fittable to a commercially available fastener gun, and which can be easily removed from the fastener gun when desired, the fastener gun mount (and possibly also the pipe clip magazine) could be provided as an integral part of a dedicated fastener gun.

A working advantage of the pipe clip dispensing device described above with reference to the drawings is that it will automate a number of actions involved in pushing a pipe clip onto a pipe and then securing it to a support such as a wall. The pipe clips are delivered onto the pipe by the pipe clip loading device and then the fastener gun is used to drive a fastener through the fastener passage and into the support. This is much easier and more time efficient than manually placing each clip over the pipe and then hammering a fastener into the support.

The device ensures that the pipe clip is held in a position adjacent the outlet of the clip cartridge suitable for pushing the clip directly onto a pipe so that it engages the pipe. Additionally, it enables the safety feature on the gun to be disabled by pushing the gun onto the pipe clip cartridge when the pipe clip cartridge is in contact with a support, which causes the cartridge to pivot relative to the fastener gun and line up the fastener to be driven with the fastener passage in the pipe clip. Thus, the device is able to be used with standard fastener guns such as the PASLODE IMPULSE 30 (trade marks) nail gun which have a safety feature that requires a safety or work contact element to be displaced rearward relative to the fastener gun by pushing it against a working surface before the gun can be operated.

Another working advantage of the pipe clip dispensing device described above with reference to the drawings is that it is able to be used with a fastener device such as a nail gun that is a widely used and widely owned piece of equipment for tradesmen. Therefore, a tradesman will not have to acquire a new tool to practise the invention. Rather they can simply mount their pipe clip dispensing device on their nail gun each time it is to be used.

This is quickly and easily accomplished by sliding the gun mounting over a rail on the handle of the nail gun.

It will of course be realized that the above has been given only by way of illustrative example of the invention and that all such modifications and variations thereto, as would be apparent to persons skilled in the art, are deemed to fall within the broad scope and ambit of the invention as is herein set forth.

1. A pipe clip dispensing device for facilitating mounting of a pipe to a support, the pipe clip dispensing device comprising:
a pipe clip cartridge defining an internal pipe clip chamber for receiving a plurality of pipe clips therein and providing a pipe clip positioning region for holding and positioning a pipe clip of the plurality of pipe clips for fixing to the support by a fastener delivered from a fastener delivery part of a fastener gun; and
a fastener gun mounting for mounting the clip cartridge on the fastener gun, wherein the clip cartridge is coupled to the fastener gun mounting such that the positioning region is moveable towards and away from the fastener delivery part of the fastener gun.

2. A pipe clip dispensing device as claimed in claim 1, wherein the clip cartridge is configured so that in use a pipe clip being held and positioned by the pipe clip positioning region moves with the holding region, so that the pipe clip is moveable towards and away from the fastener delivery part of the fastener gun.

3. A pipe clip dispensing device as claimed in claim 1, wherein the pipe clip positioning region comprises a contact region for contacting and bearing against a work contact element of a safety mechanism of a fastener gun.

4. A pipe clip dispensing device as claimed in claim 1, wherein the pipe clip cartridge is pivotally coupled to the fastener gun mounting.

5. A pipe clip dispensing device as claimed in claim 4, wherein the pipe clip dispensing device comprises a pivot joint by which the pipe clip cartridge is mounted on the fastener gun, the pivot joint comprising at least one first pivot part provided on the pipe clip cartridge and at least one second pivot part provided on the fastener gun mounting, and a pivotal connection between the at least one first pivot part and the at least one second pivot part so that the pipe clip cartridge can pivot relative to the fastener gun mounting.

6. A pipe clip dispensing device as claimed in claim 5, wherein the at least one first pivot part is provided on a side of the clip cartridge distal from the gun mount.

7. A pipe clip dispensing device as claimed in claim 1, wherein the pipe clip cartridge comprises a cartridge body having a pipe clip inlet through which a plurality of pipe clips is fed into the cartridge and a pipe clip outlet configured to allow pipe clips to exit the cartridge body therethrough, and wherein the pipe clip outlet is configured to allow a pipe clip to be mounted on a pipe before exiting the cartridge body, and to exit the cartridge body therethrough after mounting on a pipe.

8. (canceled)

9. A pipe clip dispensing device as claimed in claim 7, wherein the pipe clip outlet is formed substantially at the pipe clip positioning region.

10. (canceled)

11. A pipe clip dispensing device as claimed in claim 1, wherein the pipe clip cartridge provides a clip path from a clip inlet of the pipe clip cartridge to the pipe clip positioning region, wherein the clip path provides clip guiding formations for co-operating with complementary guide formations provided on each clip.

12. (canceled)

13. A pipe clip dispensing device as claimed in claim 11, wherein the clip guiding formations are oriented substantially in a direction in which the plurality of clips is progressively advanced along the clip path.

14. (canceled)

15. A pipe clip dispensing device as claimed in claim 13, wherein at least two clip guiding formations are provided asymmetrically on opposed sides of the clip path.

16. (canceled)

17. A pipe clip dispensing device as claimed in claim 1, wherein the pipe clip positioning region comprises a receiving formation for receiving and positioning at least part of a post of a pipe clip, wherein the post provides a fastener passage therein.

18. A pipe clip dispensing device as claimed in claim 1, wherein the pipe clip cartridge comprises a clip advancing arrangement for advancing the any remaining clips of the plurality of clips each time a clip exits the clip cartridge.

19. A pipe clip dispensing device as claimed in claim 1, wherein the pipe clip positioning region comprises a clip locator for engaging a clip and locating it in position for mounting on a pipe.

20. (canceled)

21. A pipe clip dispensing device as claimed in claim 19, wherein the clip locator is configured to abut against a fixing formation or post of a pipe clip.

22. A pipe clip dispensing device as claimed in claim 1, wherein the fastener gun mounting comprises a mounting member for releasable mounting to a complementary mounting formation on the fastener gun.

23. (canceled)

24. A pipe clip dispensing device as claimed in claim 1, wherein the fastener gun mounting comprises opposed side parts which co-operate to lock the fastener gun mounting in position relative to a part of the fastener gun which extends between the opposed side parts.

25-26. (canceled)

27. A pipe clip dispensing device for facilitating mounting of a pipe to a support, the pipe clip dispensing device comprising:
a pipe clip cartridge defining an internal pipe clip chamber for receiving a plurality of pipe clips therein and providing a pipe clip positioning region for holding and positioning a pipe clip of the plurality of pipe clips for fixing to the support by a fastener delivered from a fastener delivery part of a fastener gun; and
a fastener gun;
wherein the clip cartridge is coupled to a mounting part of the fastener gun such that the positioning region is moveable towards and away from the fastener delivery part of the fastener gun.

28. A method of mounting a pipe clip on a support for holding a pipe, the method comprising:
providing a pipe clip dispensing device in accordance with claim 1, mounted to a fastener gun, the pipe clip dispensing device having a plurality of pipe clips loaded therein with a leading pipe clip in the positioning region;
mounting the pipe clip dispensing device up against a pipe on a support so that the leading pipe clip is pushed onto the pipe which is received in a pipe receiving formation of the leading pipe clip;
moving the fastener gun relative to the pipe receiving formation of the pipe clip cartridge so that a fastener dispensing part of the fastener gun is moved closer to the leading pipe clip; and
operating the fastener gun to drive a fastener from the fastener dispensing part of the fastener gun into a fastener passage of the leading pipe clip and into the support whereby to fix the pipe clip to the support.

29. A string of pipe clips for use in a pipe clip dispensing device for mounting a pipe on a support, the string of pipe clips comprising:
a plurality of pipe clips arranged in a line, wherein adjacent pipe clips are connected to each other by a breakable connecting element; and
wherein each pipe clip has clip guide formations for co-operating with complementary clip guiding formations of a pipe clip cartridge, the clip guide formations comprising projections, grooves, or a combination of at least one projection and at least one groove, provided on the pipe clip and oriented substantially parallel to the length direction of the line of pipe clips.

30. (canceled)

31. (canceled)
